(19) United States
(12) Patent Application Publication
(10) Pub. No.: US 2008/0220336 A1
(43) Pub. Date: Sep. 11, 2008

(54) ELECTROLYTE FOR RECHARGEABLE LITHIUM BATTERY AND RECHARGEABLE LITHIUM BATTERY COMPRISING SAME

(75) Inventors: In-Tae MUN, Yongin-si (KR); Sae-Weon Roh, Yongin-si (KR); Euy-Young Jung, Yongin-si (KR); Soon-Ok Do, Yongin-si (KR); Jin-Bum Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/780,935

(22) Filed: Jul. 20, 2007

(30) Foreign Application Priority Data
Mar. 8, 2007 (KR) 10-2007-0022928

(51) Int. Cl. H01M 6/16

(52) U.S. Cl. 429/332; 429/338

(57) ABSTRACT

The electrolyte for a rechargeable lithium battery includes a non-aqueous organic solvent including 10 to 20 volume % of cyclic carbonate, a dinitrile-based compound, and a lithium salt. The electrolyte can prevent a voltage drop when the rechargeable lithium battery is exposed to high temperatures for a long period of time.

### CROSS-REFERENCE TO RELATED APPLICATION

This application claims priority to and the benefit of Korean Patent Application No. 2007-0022928 filed in the Korean Intellectual Property Office on Mar. 8, 2007, the entire content of which is incorporated herein by reference.

### BACKGROUND OF THE INVENTION

1. Field of the Invention

Aspects of the present invention relates to an electrolyte for a rechargeable lithium battery and a rechargeable lithium battery including the same.

2. Description of the Related Art

Recently, portable electronic devices have become more popular due to the reduction in the size and weight of such devices. In order to provide power for small electronic devices, research has been conducted to develop batteries, and in particular rechargeable lithium batteries having a high energy density. Lithium-transition element oxides have been used as positive active materials for rechargeable lithium batteries, and crystalline or amorphous carbon or carbon composites have been used as negative active materials. In order to fabricate positive and negative electrodes, positive and negative active materials are coated onto current collectors, at appropriate thicknesses and lengths, to form films. The positive and negative electrodes are then wound or stacked while interposing an insulating separator there between, to fabricate electrode assemblies. The electrode assemblies are put into a can or case, and an electrolyte solution is injected therein, to fabricate prismatic rechargeable batteries.

Many rechargeable lithium batteries experience a problematic drop in voltage when exposed to high temperatures for long periods of time, resulting in a deterioration of cycle-life.

### SUMMARY OF THE INVENTION

Various embodiments of the present invention provide an electrolyte for a rechargeable lithium battery that can inhibit a voltage drop of a rechargeable lithium battery that has been exposed to high temperatures for extended periods of time.

According to various embodiments of the present invention, provided is an electrolyte for a rechargeable lithium battery that includes a non-aqueous organic solvent, including from 10 to 20 volume % of a cyclic carbonate, a dinitrile-based compound, and a lithium salt.

In some embodiments the non-aqueous organic solvent includes from 15 to 20 volume % of a cyclic carbonate.

In various embodiments the cyclic carbonate includes at least one compound selected from the group consisting of ethylene carbonate, propylene carbonate, butylene carbonate, vinyl carbonate, vinylethylene carbonate, and a combination thereof. According to some embodiments, ethylene carbonate is appropriate for the cyclic carbonate.

The non-aqueous organic solvent can include a linear carbonate.

The linear carbonate may include at least one compound selected from the group consisting of dimethyl carbonate, diethyl carbonate, dipropyl carbonate, methylpropyl carbonate, ethylpropyl carbonate, methylethyl carbonate, ethylmethyl carbonate, and a combination thereof.

The dinitrile-based compound can be represented by the following Formula 1.

N≡C—R—C≡N Formula 1

In Formula 1, R can be a substituted or unsubstituted alkylene, or a substituted or unsubstituted cycloalkyl. The substituted alkylene and cycloalkyl can include a halogen substituent.

The dinitrile-based compound may include at least one compound selected from the group consisting of adiponitrile, succinonitrile, glutaronitrile, suberoonitrile, pimelonitrile, and a combination thereof.

The dinitrile-based compound may be present in an amount of from 0.01 to 15 wt %, based on the total weight of the electrolyte. The dinitrile-based compound may be present in an amount of from 0.01 to 10 wt %, based on the total weight of the electrolyte.

The lithium salt may include at least one compound selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where, x and y are natural numbers), LiCl, Lil, and a combination thereof.

According to some embodiments of the present invention, provided is a rechargeable lithium battery that includes: a negative electrode, including a negative active material to dope and dedope lithium; a positive electrode, including a positive active material to intercalate and deintercalate lithium; and the above electrolyte.

The positive electrode has an active mass density of 3.7 g/cc or more. According to one embodiment of the present invention, the positive electrode has an active mass density of 3.7 to 4.1 g/cc. According to another embodiment of the present invention, the positive electrode has an active mass density of 3.7 to 3.9 g/cc.

According to yet another embodiment of the present invention, provided is a rechargeable lithium battery that includes: the above electrolyte; a negative electrode including a negative active material to dope and dedope lithium; and a positive electrode, including a positive active material to intercalate and deintercalate lithium and having an active mass density of 3.7 g/cc or more.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view of a rechargeable lithium battery according to one embodiment of the present invention.

FIG. 2 is a graph showing OCV voltage measurement results of rechargeable lithium battery cells according to Examples 2-4 and Comparative Examples 3-4.

FIG. 3 is a graph showing capacity measurement results of rechargeable lithium battery cells according to Examples 15-17.

### DETAILED DESCRIPTION OF THE EMBODIMENTS

Reference will now be made in detail to the various embodiments of the present invention, examples of which are illustrated in the accompanying drawings. Like reference numerals refer to the like elements throughout. The embodiments are described below in order to explain the present invention by referring to the figures.

Related art rechargeable lithium batteries undergo a voltage drop, when exposed to a high temperature (about 60° C.) for an extended period of time, resulting in the deterioration of cycle-life and cell performance.

Aspects of the present invention provide an electrolyte for a rechargeable lithium battery that can prevent a voltage drop from exposure to high temperatures for extended time periods.

An electrolyte for a rechargeable lithium battery according to one embodiment includes a non-aqueous organic solvent, including from 10 to 20 volume % of a cyclic carbonate, a dinitrile-based compound, and a lithium salt.

According to one embodiment, the cyclic carbonate may be present in an amount of from 10 to 20 volume % based on the total weight of the non-aqueous organic solvent. According to another embodiment of the present invention, the cyclic carbonate may be present in an amount of from 15 to 20 volume % based on the total weight of the non-aqueous organic solvent. When the cyclic carbonate content is within the above range, the voltage can be maintained, and the cycle-life can be preserved. However, when it is less than 10 volume %, a dielectric constant of the electrolyte may be reduced, and thus an electrolytic additive and a salt may not be dissolved adequately. When the cyclic carbonate content is more than 20 volume %, the voltage may be poorly maintained.

The cyclic carbonate includes at least one selected from the group consisting of ethylene carbonate, propylene carbonate, butylene carbonate, vinyl carbonate, vinylethylene carbonate, and a combination thereof. Ethylene carbonate can be an appropriate cyclic carbonate.

The non-aqueous organic solvent can further include a linear carbonate. The linear carbonate may include at least one selected from the group consisting of dimethyl carbonate, diethyl carbonate, dipropyl carbonate, methylpropyl carbonate, ethylpropyl carbonate, methylethyl carbonate, ethylmethyl carbonate, and a combination thereof.

The dinitrile-based compound may be represented by the following Formula 1.

N≡C—R—C≡N Formula 1:

In Formula 1, R can be a substituted or unsubstituted alkylene or a substituted or unsubstituted cycloalkyl. The substituted alkylene and/or cycloalkyl can include a halogen substituent.

The alkylene may be a C₁ to C₁₂ alkylene. According to one embodiment, the alkylene is a C₂ to C₆ alkylene. The cycloalkyl may be a C₄ to C₁₂ cycloalkyl. According to one embodiment, the cycloalkyl can be a C₆ to C₁₂ cycloalkyl.

The dinitrile-based compound may include at least one selected from the group consisting of adiponitrile, succinonitrile, glutaronitrile, suberoonitrile, pimelonitrile, and a combination thereof. The dinitrile-based compound can be adiponitrile.

The dinitrile-based compound may be present in an amount of from 0.01 to 15 wt %, based on the total weight of the electrolyte. According to one embodiment, the dinitrile-based compound may be present in an amount of from 0.01 to 10 wt %, based on the total weight of the electrolyte. According to another embodiment, the dinitrile-based compound may be present in an amount of from 0.1 to 5 wt %, based on the total weight of the electrolyte. Within the above range, a voltage drop can be prevented when a rechargeable lithium battery is exposed to high temperatures for extended periods of time.

The lithium salts act as a lithium-ion source, helping basic battery operation.

The lithium salt may include at least one selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where, x and y are natural numbers), LiCl, Lil, and a combination thereof.

The electrolyte for a rechargeable lithium battery according to one embodiment can reduce a voltage drop when the battery is exposed to high temperatures for extended periods of time, resulting in an improvement of the cycle-life characteristics and battery performance.

Rechargeable lithium batteries may be classified as lithium ion batteries, lithium ion polymer batteries, and lithium polymer batteries, according to the presence of a separator and the kind of electrolyte used in the battery. The rechargeable lithium batteries may have a variety of shapes and sizes, including cylindrical, prismatic, or coin-type shapes. The rechargeable lithium batteries may have a thin film configuration, or be bulky in size. Structures and fabricating methods for lithium ion batteries pertaining to aspects of the present invention are well known in the art.

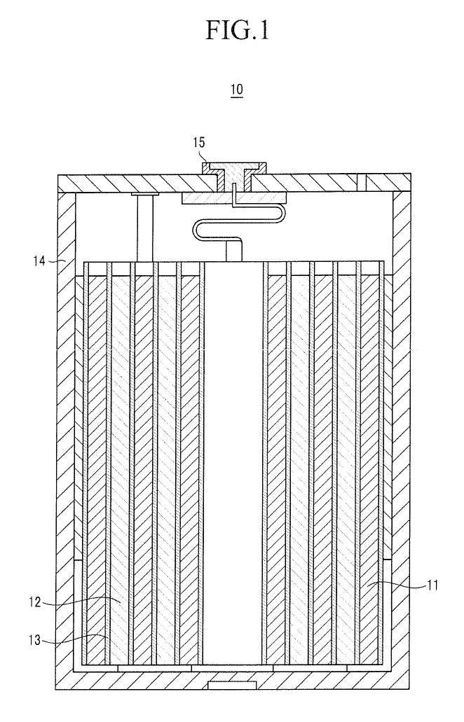

FIG. 1 shows a representative structure of a rechargeable lithium battery according to one embodiment of the present invention. Referring to FIG. 1, the rechargeable lithium battery 10 is constructed of a positive electrode 11, a negative electrode 12, a separator 13 interposed between the positive electrode 11 and the negative electrode 12, and an electrolyte (not shown) in which the separator 13 is immersed. The battery 10 can further include a cell case 14 and a sealing member 15 to seal the cell case 14.

The negative electrode 12 can include a negative active material to dope and dedope lithium. The positive electrode 11 can include a positive active material to intercalate and deintercalate lithium. The electrolyte can include a non-aqueous organic solvent, including from 10 to 20 volume % of a cyclic carbonate, a dinitrile-based compound, and a lithium salt. The electrolyte can be the same as described above.

The positive electrode 11 includes a current collector and a positive active material layer disposed on the current collector. The positive active material layer can include a positive active material to intercalate and deintercalate lithium, a binder, and a conductive agent.

The positive electrode 11 can have an active mass density of 3.7 g/cc, or more. According to one embodiment, the positive electrode 11 can have an active mass density ranging from 3.7 to 4.1 g/cc. According to another embodiment, the positive electrode 11 can have an active mass density ranging from 3.7 to 3.9 g/cc. When the positive electrode 11 has an active mass density of 3.7 g/cc, or more, the cell capacity can be increased. On the contrary, when the positive electrode 11 has an active mass density of less than 3.7 g/cc, a capacity increase over a conventional battery may not occur, even though a high voltage battery can be realized.

Aspects of the present invention can provide a rechargeable lithium battery that has a high voltage of 3.6V. The electrolyte inhibits a voltage drop that may occur at a high temperature, resulting in an improvement of the cell characteristics and cycle-life.

The positive active material can include a composite oxide, including lithium and a metal selected from the group consisting of cobalt, manganese, nickel, and a combination thereof. The positive active material can be specifically exemplified by compounds of the following Formulas 2 to 25:

LiₐA_{1-b}B_{b}D₂, wherein 0.95≦a≦1.1, and 0≦b≦0.5; Formula 2:

LiₐE_{1-b}B_{b}O_{2-c}F_{c}, wherein 0.95≦a≦1.1, 0≦b≦0.5, and 0≦c≦0.05; Formula 3:

LiE_{2-b}B_{b}O_{4-c}F_{c}, wherein 0≦b≦0.5, and 0≦c≦0.05; Formula 4:

LiₐNi_{1-b-c}Co_{b}BcD_{α}, wherein 0.95≦a≦1.1, 0≦b≦0.5, 0≦c≦0.05, and 0<α≦2; Formula 5:

LiₐNi_{1-b-c}Co_{b}B_{c}O_{2-α}F_{α}, wherein 0.95≦a≦1.1, 0≦b≦0.5, 0≦c≦0.05, and 0<α<2; Formula 6:

LiₐNi_{1-b-c}Co_{b}B_{c}O_{2-α}F₂, wherein 0.95≦a≦1.1, 0≦b≦0.5, 0≦c≦0.05, and 0<α<2; Formula 7:

LiₐNi_{1-b-c}Mn_{b}B_{c}D_{α}, wherein 0.95≦a≦1.1, 0≦b≦0.5, 0≦c≦0.05, and 0<α≦2; Formula 8:

LiₐNi_{1-b-c}Mn_{b}B_{c}O_{2-α}F_{α}, wherein 0.95≦a≦1.1, 0≦b≦0.5, 0≦c≦0.05, and 0<α<2; Formula 9:

LiₐNi_{1-b-c}Mn_{b}B_{c}O_{2-α}F₂, wherein 0.95≦a≦1.1, 0≦b≦0.5, 0≦c≦0.05, and 0<α<2; Formula 10:

LiₐNi_{b}E_{c}G_{d}O₂, wherein Formula 11, 0.90≦a≦1.1, 0≦b≦0.9, 0≦c≦0.5, and 0.001≦d≦0.1; Formula 11:

LiₐNi_{b}Co_{c}Mn_{d}GeO₂, wherein Formula 12, 0.90≦a≦1.1, 0≦b≦0.9, 0≦c≦0.5, 0≦d≦0.5, and 0.001≦e≦0.1; Formula 12:

LiₐNiG_{b}O₂, wherein 0.90≦a≦1.1, and 0.001≦b≦0.1; Formula 13:

LiₐCoG_{b}O₂, wherein 0.90≦a≦1.1, and 0.001≦b≦0.1; Formula 14:

LiₐMnG_{b}O₂, wherein 15, 0.90≦a≦1.1, and 0.001≦b≦0.1; Formula 15:

LiₐMn₂G_{b}O₄, wherein 16, 0.90≦a≦1.1, and 0.001≦b≦0.1; Formula 16:

QO₂; Formula 17:

QS₂; Formula 18:

LiQS₂; Formula 19:

V₂O₅; Formula 20:

LiV₂O₅; Formula 21:

LilO₂; Formula 22:

LiNiVO₄; Formula 23:

Li_{3-f}J₂(PO₄)₃, wherein (0≦f≦3); and Formula 24:

Li_{3-f}Fe₂(PO₄)₃, wherein (0≦f≦2). Formula 25:

In the above Formulas 2 to 25:

A is selected from the group consisting of Ni, Co, Mn, and a combination thereof;

B is selected from the group consisting of Al, Ni, Co, Mn, Cr, Fe, Mg, Sr, V, a rare earth element, and a combination thereof;

D is selected from the group consisting of O, F, S, P, and a combination thereof;

E is selected from the group consisting of Co, Mn, and a combination thereof;

F is selected from the group consisting of F, S, P, and a combination thereof;

G is a transition element or a lanthanide element selected from the group consisting of Al, Cr, Mn, Fe, Mg, La, Ce, Sr, V, and a combination thereof;

Q is selected from the group consisting of Ti, Mo, Mn, and a combination thereof;

I is selected from the group consisting of Cr, V, Fe, Sc, Y, and a combination thereof; and

J is selected from the group consisting of V, Cr, Mn, Co, Ni, Cu, and a combination thereof.

The positive active material may be at least one selected from the group consisting of elemental sulfur (S₈), Li₂Sₙ(n≧1), Li₂Sₙ(n≧1), an organic sulfur compound, and a carbon-sulfur polymer ((C₂S_{f})ₙ: f=2.5 to 50, n≧2). The Li₂Sₙ(n≧1) and the Li₂Sₙ(n≧1) can be dissolved in a catholyte.

Examples of the binder include, but are not limited to, polyvinylalcohol, carboxylmethyl cellulose, hydroxypropylene cellulose, diacetylene cellulose, polyvinylchloride, polyvinylpyrrolidone, polytetrafluoroethylene, polyvinylidenefluoride, polyethylene, and polypropylene.

Any electrically conductive material can be used as a conductive agent unless it causes a detrimental chemical change. Examples of the conductive agent include: natural graphite; artificial graphite; carbon black; acetylene black; ketjen black; carbon fiber; a metal powder or a metal fiber including copper, nickel, aluminum, or silver; a polyphenylene derivative; and the like.

The solvent can he N-methylpyrrolidone, but it is not limited thereto.

The current collector may be selected from the group consisting of copper foil, nickel foil, stainless steel foil, titanium foil, nickel foam, copper foam, a polymer substrate coated with a conductive metal, and a combination thereof.

The negative electrode includes a current collector and a negative active material layer. The negative electrode can be prepared by applying a mixture onto the current collector. The mixture can include a negative active material to dope and dedope lithium and a binder. The mixture can also include a conductive agent mixed in a solvent. Methods of manufacturing a negative electrode are well known, and thus are not described in detail in the present specification.

The rechargeable lithium battery generally includes a separator between the positive electrode and the negative electrode. The separator may include polyethylene, polypropylene, or polyvinylidene fluoride, or multi-layers thereof. For example, a polyethylene/polypropylene double-layered separator, a polyethylene/polypropylene/polyethylene triple-layered separator, or a polypropylene/polyethylene/polypropylene triple-layered separator.

The following examples illustrate aspects of the present invention in more detail. These examples, however, should not in any sense be interpreted as limiting the scope of the present invention.

### EXAMPLE 1

Artificial graphite was mixed with a polyvinylidene fluoride binder, in a weight ratio of 96:4, in an N-methylpyrrolidone solvent, to prepare a negative electrode slurry.

A 14 μm thick coating of the slurry was applied to a copper foil, dried at 135° C. for three hours or more, and pressed, to fabricate a negative electrode.

A positive electrode slurry was prepared by dispersing an LiCoO₂ positive active material, a polyvinylidenefluoride binder, and a carbon conductive agent, in a weight ratio of 96:2:2, in an N-methylpyrrolidone solvent. A 60 μm coating of the positive electrode slurry was applied to an aluminum foil, dried at 135° C. for three hours or more, and compressed, to fabricate a positive electrode. Herein, the positive electrode had a mass density of 3.7 g/cc.

A non-aqueous-based electrolyte solution was prepared by mixing ethylmethylcarbonate (EMC), dimethylcarbonate (DMC), and ethylenecarbonate (EC), in a weight ratio of 45:45:10, to prepare a mixed solvent. Then adiponitrile and 1.3M of LiPF₆ were added to the mixed solvent. The adiponitrile was added in an amount of 0.5 wt % based on the entire amount of the electrolyte solution.

The prepared negative and positive electrodes were spirally wound with a porous polypropylene film separator therebetween, compressed together, then inserted in a battery case. The electrolyte solution was injected into the battery case, obtaining a rechargeable lithium battery cell. Herein, the electrolyte solution was included in an amount of 4.6 g.

### EXAMPLE 2

A rechargeable lithium battery cell was fabricated by the same method as in Example 1, except that ethylmethylcarbonate (EMC), dimethylcarbonate (DMC), and ethylenecarbonate (EC) were mixed in a ratio of 45:45:10, to prepare a mixed solvent, and then adiponitrile, 1.3M of LiPF₆, vinylcarbonate, and fluoroethylenecarbonate, were added thereto to prepare a non-aqueous-based electrolyte solution. Herein, 0.5 wt % of adiponitrile, 5 wt % of vinylcarbonate, and 5 wt % of fluoroethylenecarbonate were included, based on the entire amount of the electrolyte solution.

### EXAMPLE 3

A rechargeable lithium battery cell was fabricated by the same method as in Example 2, except that adiponitrile was included in an amount of 1 wt %, based on the entire amount of the electrolyte solution.

### EXAMPLE 4

A rechargeable lithium battery cell was fabricated by the same method as in Example 2, except that adiponitrile was included in an amount of 5 wt %, based on the entire amount of the electrolyte solution.

### EXAMPLE 5

A rechargeable lithium battery cell was fabricated by the same method as in Example 2, except that adiponitrile was included in an amount of 10 wt %, based on the entire amount of the electrolyte solution.

### EXAMPLE 6

A rechargeable lithium battery cell was fabricated by the same method as in Example 2, except that adiponitrile and succinonitrile were each included in an amount of 0.5 wt %, based on the entire amount of the electrolyte solution.

### EXAMPLE 7

A rechargeable lithium battery cell was fabricated by the same method as in Example 6, except that succinonitrile was included in an amount of 5 wt %, based on the entire amount of the electrolyte solution.

### EXAMPLE 8

A rechargeable lithium battery cell was fabricated by the same method as in Example 6, except that succinonitrile was included in an amount of 10 wt %, based on the entire amount of the electrolyte solution.

### EXAMPLE 9

A rechargeable lithium battery cell was fabricated by the same method as in Example 2, except that adiponitrile was included in an amount of 0.5 wt % and glutaronitrile in an amount of 0.1 wt %, based on the entire amount of the electrolyte solution.

### EXAMPLE 10

A rechargeable lithium battery cell was fabricated by the same method as in Example 2, except that adiponitrile was included in an amount of 0.5 wt % and suberonitrile in an amount of 5 wt %, based on the entire amount of the electrolyte solution.

### EXAMPLE 11

A rechargeable lithium battery cell was fabricated by the same method as in Example 10, except that suberonitrile was included in an amount of 10 wt %, based on the entire amount of the electrolyte solution.

### EXAMPLE 12

A rechargeable lithium battery cell was fabricated by the same method as in Example 1, except that propylenecarbonate (PC), methylethylcarbonate (MEC), and dipropylcarbonate (DPC), were mixed in a weight ratio of 20:40:40, to prepare a mixed solvent, and then adiponitrile and 1.3M of LiPF₆ were added thereto, preparing a non-aqueous-based electrolyte solution. Herein, adiponitrile was included in an amount of 5 wt %, based on the entire amount of the electrolyte solution.

### EXAMPLE 13

A rechargeable lithium battery cell was fabricated by the same method as in Example 1, except that a mixed solvent was prepared by mixing vinylethylenecarbonate (VEC), methylethylcarbonate (MEC), and dipropylcarbonate (DPC), in a mixing ratio of 20:40:40, to prepare a mixed solvent, and then adiponitrile and 1.3M of LiPF₆ were added thereto, preparing a non-aqueous-based electrolyte solution. Herein, adiponitrile was included in an amount of 5 wt %, based on the entire amount of the electrolyte solution.

### EXAMPLE 14

A rechargeable lithium battery cell was fabricated by the same method as in Example 1, except that propylenecarbonate (PC) and diethylcarbonate (DEC) were mixed in a weight ratio of 15:85, to prepare a mixed solvent, and then adiponitrile and 1.3M of LiPF₆ were added thereto, preparing a non-aqueous-based electrolyte solution. Herein, adiponitrile was added in an amount of 5 wt %, based on the entire amount of the electrolyte solution.

### EXAMPLE 15

Artificial graphite was mixed with a polyvinylidene fluoride binder in a weight ratio of 96:4, in an N-methylpyrrolidone solvent, preparing a negative electrode slurry.

A 14 μm thick coating of the negative electrode slurry was applied to a Cu-foil, preparing a thin substrate. The substrate was dried at 135° C., for 3 hours or more, and pressed, obtaining a negative electrode.

A positive electrode slurry was prepared by dispersing a LiCoO₂ positive-active material, a polyvinylidenefluoride binder, and a carbon conductive agent, in a weight ratio of 96:2:2, in an N-methylpyrrolidone solvent. A 60 μm thick coating of the positive electrode slurry was applied to an aluminum foil, to prepare a thin substrate. The substrate was dried at 135° C., for 3 hours or more, and pressed, obtaining a positive electrode. Herein, the positive electrode had a mass density of 3.75 g/cc.

Then, a non-aqueous-based electrolyte solution was prepared by mixing ethylmethylcarbonate (EMC), dimethylcarbonate (DMC), and ethylenecarbonate (EC), in a weight ratio of 2:6:2, to prepare a mixed solvent. Then adiponitrile, vinylcarbonate, fluoroethylenecarbonate, and 1.3M of LiPF₆, were added thereto. Herein, 1 wt % of adiponitrile, 5 wt % of vinylcarbonate, and 5 wt % of fluoroethylenecarbonate were included, based on the entire amount of the electrolyte solution.

The prepared negative and positive electrodes were spirally wound with a separator formed of a porous polypropylene film, then compressed together and inserted in a battery case. Then, the electrolyte solution was injected into the battery cell case, obtaining a rechargeable lithium battery cell. Herein, the electrolyte solution was included in an amount of 4.6 g.

### EXAMPLE 16

A rechargeable lithium battery cell was fabricated by the same method as in Example 15, except that the positive electrode had a mass density of 3.8 g/cc.

### EXAMPLE 17

A rechargeable lithium battery cell was fabricated by the same method as in Example 15, except that the positive electrode had a mass density of 3.9 g/cc.

### EXAMPLE 18

A rechargeable lithium battery cell was fabricated by the same method as in Example 15, except that the positive electrode had a mass density of 4.1 g/cc.

### COMPARATIVE EXAMPLE 1

A rechargeable lithium battery cell was fabricated by the same method as in Example 1, except the adiponitrile was not added.

### COMPARATIVE EXAMPLE 2

A rechargeable lithium battery cell was fabricated by the same method as in Example 1, except that ethylenecarbonate (EC), ethylmethylcarbonate (EMC), and dimethylenecarbonate (DMC), were mixed in a weight ratio of 30:30:40, to prepare a mixed solvent. Then, adiponitrile and 1.3M of LiPF₆ were added thereto, to prepare a non-aqueous-based electrolyte solution. The adiponitrile was added in an amount of 5 wt %, based on the entire amount of the electrolyte solution.

### COMPARATIVE EXAMPLE 3

A rechargeable lithium battery cell was fabricated by the same method as in Example 2, except the adiponitrile was not added.

### COMPARATIVE EXAMPLE 4

A rechargeable lithium battery cell was fabricated by the same method as in Example 1, except that the ethylenecarbonate (EC), ethylmethylcarbonate (EMC), and dimethylenecarbonate (DMC), were mixed in a weight ratio of 30:30:40, to prepare a mixed solvent, and then vinylcarbonate, fluoroethylenecarbonate, and 1.3M of LiPF₆, were added thereto, to prepare a non-aqueous-based electrolyte solution. Herein, 0.5 wt % of the vinylcarbonate and 5 wt % of the fluoroethylenecarbonate, based on the entire amount of the electrolyte solution, were included.

### Characteristics of Battery Cells Exposed to A High Temperature

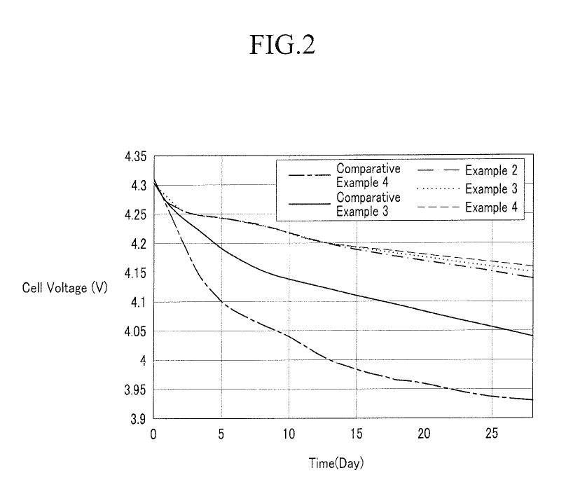

The rechargeable lithium battery cells according to Examples 2-4 and Comparative Examples 3-4, were treated with the following formation processes. The cells were charged with 0.2 C and 4.35V, in a Constant Current (CC)/Constant Voltage (CV) mode. When the cells had a current amount of 1/20 C, they were discharged at up to 3V, for 0.2 C in a CC mode. Next, the battery cells were charged with 0.5 C at 4.35V, in a CC/CV mode. When they had a current amount of 1/20 C charging was stopped, and the cells were exposed to a high temperature for 4 weeks. Then, they were measured regarding an open charge voltage (OCV), at 1000 khz. The results are shown in Table 1 and FIG. 2.

TABLE 1

| | Ethylene | | OCV |
|---|---|---|---|
| | carbonate | Adiponitrile | after 4 weeks (V) |
| Example 2 | 10 wt % | 0.5 wt % | 4.14 |
| Example 3 | 10 wt % | 1.0 wt % | 4.15 |
| Example 4 | 10 wt % | 5 wt % | 4.16 |
| Comparative Example 3 | 10 wt % | 0 wt % | 4.03 |
| Comparative Example 4 | 30 wt % | 0 wt % | 3.93 |

Referring to FIG. 2 and Table 1, the rechargeable lithium battery cells according to Examples 2-4, which included 10% of ethylenecarbonate, and respectively 1.0 wt %, 0.5 wt %, and 5 wt % of adiponitrile, turned out to have a higher OCV than those of Comparative Examples 3 and 4, after they were heated at a temperature of 60° C. for 4 weeks.

In addition, the rechargeable lithium battery cell of Comparative Example 3, which included 10% of the ethylenecarbonate, had a higher OCV than that of Comparative Example 4, which included 30% of the ethylenecarbonate, after they were heated at a temperature of 60° C. for 4 weeks.

### Voltage Measurements at High Densities

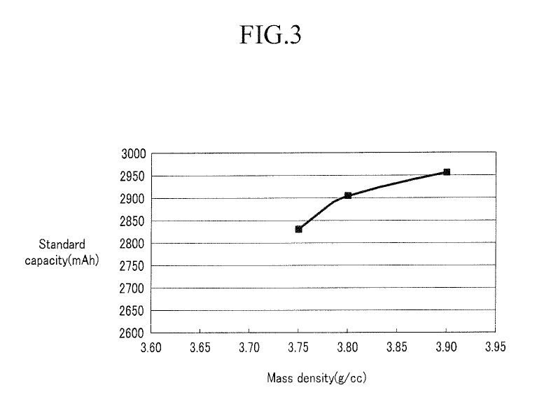

The rechargeable lithium battery cells were charged with 0.2 C and 4.35V in a CC/CV mode. When the cells had a current amount of 1/20 C charging was stopped, and they were discharged to 3V in 0.2 C of a CC mode. Next, the battery cells were charged with 0.5 C and 4.35V in a CC/CV mode. When they had a current amount of 1/20 C, they were heated at a temperature of 60° C. for 4 weeks. Then, they were measured regarding an open charge voltage (OCV) and a discharge capacity at 1000 khz. The results are provided in Table 2 and FIG. 3.

TABLE 2

| | Initial OCV (V) | OCV after 4 weeks (V) |
|---|---|---|
| Example 15 | 4.31 | 4.15 |
| Example 16 | 4.31 | 4.15 |
| Example 17 | 4.31 | 4.09 |

Referring to Table 2, the rechargeable lithium battery cells of Examples 15-17, whose positive electrodes respectively had mass densities of 3.75 g/cc, 3.8 g/cc, and 3.9 g/cc, turned out to have a high initial OCV, and also a high OCV after they were heated at a temperature of 60° C. for 4 weeks. In other words, the rechargeable lithium battery cells of Examples 15-17, did not have a voltage drop, even when they were exposed to a high temperature for a long period of time.

Also, referring to FIG. 3, the rechargeable lithium battery cells of Examples 15-17 had a remarkably high standard capacity.

In other words, the rechargeable lithium battery cells of Examples 15-17 were high-capacity battery cells with high mass densities, and did not show a voltage drop, even when they were exposed to a high temperature for a long time. The rechargeable lithium battery cell of Example 18, where the positive electrode had mass densities of 4.1 g/cc, showed similar results to those of Examples 15-17.

Accordingly, when a rechargeable lithium battery cell, including an appropriate amount of a cyclic carbonate and a dinitrile-based compound additive, was exposed to a high temperature for a long time, it had improved voltage drop characteristics.

As described above, the electrolyte solution includes a non-aqueous organic solvent, including 10 to 20 volume % of a cyclic carbonate and a dinitrile-based compound additive, and can thereby prevent a voltage drop in a rechargeable lithium battery cell exposed to a high temperature for a long time. The electrolyte solution can improve cycle-life characteristics and cell characteristics in a lithium battery cell having a high voltage and mass density.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrolyte for a rechargeable lithium battery, comprising:
a non-aqueous organic solvent comprising from 10 to 20 volume % of a cyclic carbonate;
a dinitrile-based compound; and
a lithium salt.

2. The electrolyte of claim 1, wherein the non-aqueous organic solvent comprises from 15 to 20 volume % of the cyclic carbonate.

3. The electrolyte of claim 1, wherein the cyclic carbonate comprises at least one selected from the group consisting of ethylene carbonate, propylene carbonate, butylene carbonate, vinyl carbonate, vinylethylene carbonate, and a combination thereof.

4. The electrolyte of claim 3, wherein the cyclic carbonate is ethylene carbonate.

5. The electrolyte of claim 1, wherein the non-aqueous organic solvent further comprises a linear carbonate.

6. The electrolyte of claim 5, wherein the linear carbonate is at least one selected from the group consisting of dimethyl carbonate, diethyl carbonate, dipropyl carbonate, methylpropyl carbonate, ethylpropyl carbonate, methylethyl carbonate, ethylmethyl carbonate, and a combination thereof.

7. The electrolyte of claim 1, wherein the dinitrile-based compound is represented by the following Formula 1: N≡C—R—C≡N,
wherein R is selected from the group consisting of a substituted alkylene, an unsubstituted alkylene, a substituted cycloalkyl, and an unsubstituted cycloalkyl, and
wherein the substituted alkylene and the substituted cycloalkyl comprise a halogen substituent.

8. The electrolyte of claim 7, wherein the dinitrile-based compound is at least one selected from the group consisting of adiponitrile, succinonitrile, glutaronitrile, suberoonitrile, pimelonitrile, and a combination thereof.

9. The electrolyte of claim 1, wherein the dinitrile-based compound is present in an amount of from 0.01 to 15 wt % based on the total weight of the electrolyte.

10. The electrolyte of claim 9, wherein the dinitrile-based compound is present in an amount of from 0.01 to 10 wt % based on the total weight of the electrolyte.

11. The electrolyte of claim 1, wherein the lithium salt comprises at least one selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where, x and y are natural numbers), LiCl, Lil, and a combination thereof.

12. A rechargeable lithium battery comprising:
a negative electrode including a negative active material to dope and dedope lithium;
a positive electrode including a positive active material to intercalate and deintercalate lithium; and
an electrolyte comprising,
a non-aqueous organic solvent including from 10 to 20 volume % of cyclic carbonate,
a dinitrile-based compound, and
a lithium salt.

13. The rechargeable lithium battery of claim 12, wherein the cyclic carbonate comprises at least one selected from the group consisting of ethylene carbonate, propylene carbonate, butylene carbonate, vinyl carbonate, vinylethylene carbonate, and a combination thereof.

14. The rechargeable lithium battery of claim 13, wherein the cyclic carbonate is ethylene carbonate.

15. The rechargeable lithium battery of claim 12, wherein the cyclic carbonate is ethylene carbonate.

16. The rechargeable lithium battery of claim 15, wherein the linear carbonate is at least one selected from the group consisting of dimethyl carbonate, diethyl carbonate, dipropyl carbonate, methylpropyl carbonate, ethylpropyl carbonate, methylethyl carbonate, ethylmethyl carbonate, and a combination thereof.

17. The rechargeable lithium battery of claim 12, wherein the dinitrile-based compound is represented by the following Formula 1: N≡C—R—C≡N,
wherein R is selected from the group consisting of a substituted alkylene, and an unsubstituted alkylene, a substituted cycloalkyl, an unsubstituted cycloalkyl, and
wherein the substituted alkylene and the substituted cycloalkyl comprise a halogen substituent.

18. The rechargeable lithium battery of claim 17, wherein the dinitrile-based compound is at least one selected from the group consisting of adiponitrile, succinonitrile, glutaronitrile, suberoonitrile, pimelonitrile, and a combination thereof.

19. The rechargeable lithium battery of claim 12, wherein the dinitrile-based compound is present in an amount of from 0.01 to 15 wt % based on the total weight of the electrolyte.

20. The rechargeable lithium battery of claim 12, wherein the dinitrile-based compound is present in an amount of from 0.01 to 10 wt % based on the total weight of the electrolyte.

21. The rechargeable lithium battery of claim 12, wherein the lithium salt comprises at least one selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where, x and y are natural numbers), LiCl, Lil, and a combination thereof.

22. The rechargeable lithium battery of claim 12, wherein the positive electrode has an active mass density of 3.7 g/cc or more.

23. The rechargeable lithium battery of claim 22, wherein the positive electrode has an active mass density of from 3.7 to 4.1 g/cc.

24. The rechargeable lithium battery of claim 23, wherein the positive electrode has an active mass density of from 3.7 to 3.9 g/cc.

25. A rechargeable lithium battery comprising:
an electrolyte comprising a non-aqueous organic solvent comprising,
10 to 20 volume % of a cyclic carbonate,
a dinitrile-based compound, and
a lithium salt;
a negative electrode comprising a negative active material to dope and dedope lithium; and
a positive electrode comprising a positive active material to intercalate and deintercalate lithium, and having an active mass density of 3.7 g/cc or more.

26. The rechargeable lithium battery of claim 25, wherein the positive electrode has an active mass density of from 3.7 to 4.1 g/cc.

27. The rechargeable lithium battery of claim 26, wherein the positive electrode has an active mass density of from 3.7 to 3.9 g/cc.

28. The rechargeable lithium battery of claim 25, wherein the non-aqueous organic solvent comprises from 15 to 20 volume % of the cyclic carbonate.

29. The rechargeable lithium battery of claim 25, wherein the cyclic carbonate comprises at least one selected from the group consisting of ethylene carbonate, propylene carbonate, butylene carbonate, vinyl carbonate, vinylethylene carbonate, and a combination thereof.

30. The rechargeable lithium battery of claim 29, wherein the cyclic carbonate is ethylene carbonate.

31. The rechargeable lithium battery of claim 25, wherein the non-aqueous organic solvent further comprises a linear carbonate.

32. The rechargeable lithium battery of claim 31, wherein the linear carbonate is at least one selected from the group consisting of dimethyl carbonate, diethyl carbonate, dipropyl carbonate, methylpropyl carbonate, ethylpropyl carbonate, methylethyl carbonate, ethylmethyl carbonate, and a combination thereof.

33. The rechargeable lithium battery of claim 25, wherein the dinitrile-based compound is represented by the following Formula 1: N≡C—R—C≡N,
wherein, the R is selected from the group consisting of a substituted alkylene, an unsubstituted alkylene, a substituted cycloalkyl, and an unsubstituted cycloalkyl, and
wherein the substituted alkylene and the substituted cycloalkyl comprise a halogen substituent.

34. The rechargeable lithium battery of claim 33, wherein the dinitrile-based compound is at least one selected from the group consisting of adiponitrile, succinonitrile, glutaronitrile, suberoonitrile, pimelonitrile, and a combination thereof.

35. The rechargeable lithium battery of claim 25, wherein the dinitrile-based compound is present in an amount of from 0.01 to 15 wt % based on the total weight of the electrolyte.

36. The rechargeable lithium battery of claim 35, wherein the dinitrile-based compound is present in an amount of from 0.01 to 10 wt % based on the total weight of the electrolyte.

37. The rechargeable lithium battery of claim 25, wherein the lithium salt comprises at least one selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where, x and y are natural numbers), LiCl, Lil, and a combination thereof.

38. The electrolyte of claim 7, wherein the substituted akylene and the unsubstituted alkyene comprise a C1 to C12 alkylene.

39. The electrolyte of claim 7, wherein the substituted cycloalkyl and the unsubstituted cycloalkyl comprise a C4 to C12 cycloalkyl.

40. The rechargeable lithium battery of claim 17, wherein the substituted akylene and the unsubstituted alkyene comprise a C2 to C6 alkylene.

41. The rechargeable lithium battery of claim 17, wherein the substituted cycloalkyl and the unsubstituted cycloalkyl comprise a C6 to C12 cycloalkyl.

42. The rechargeable lithium battery of claim 12, wherein the positive active material comprises a composite lithium oxide and a metal selected from the group consisting of cobalt, manganese, nickel, and a combination thereof.

43. The rechargeable lithium battery of claim 25, wherein the positive active material comprises a composite lithium oxide and a metal selected from the group consisting of cobalt, manganese, nickel, and a combination thereof.
